(19) United States
(12) Patent Application Publication
(10) Pub. No.: US 2015/0113300 A1
(43) Pub. Date: Apr. 23, 2015

(54) BATTERY OPERATED COMPUTER SYSTEM

(71) Applicant: NVIDIA Corporation, Santa Clara, CA (US)

(72) Inventors: Peter Cumming, Wolton-Under-Edge (GB); Stephen Felix, Bristol (GB)

(73) Assignee: NVIDIA Corporation, Santa Clara, CA (US)

(21) Appl. No.: 14/059,661

(22) Filed: Oct. 22, 2013

(51) Int. Cl. G06F 1/32

(52) U.S. Cl. CPC G06F 1/3296
USPC 713/320; 713/322

(57) ABSTRACT

Disclosed herein is a computer system operating on a local power supply of finite capacity has a plurality of system components each connected to a voltage supply system to draw current for their operation. The computer system includes a measuring circuit connected to detect prevailing usage of the local power supply, for example, a battery. The supply system is connected to receive an indication from the measuring circuit of excessive usage and is adapted to reduce the available supply voltage to selected ones of the system components. Each system component is associated with a clock controller which selects a clock frequency for operation of a component in dependence on the available voltage supply. Also disclosed is a supply system for a computer device operating on a local power supply of finite capacity.

### FIELD

This disclosure relates to battery powered computer systems.

### BACKGROUND

Many battery powered computer systems have separately powered components which together can draw more current (EDP) than is available from the system battery. One example of a battery powered computer system is a handheld cellular or wireless terminal. Such wireless terminals have a plurality of components, including for example, a compute component, a graphics component and a communications component which individually depend on current drawn from the system battery. If these components draw excessive current, the battery will drop out and the computer system will crash.

### SUMMARY

According to the present disclosure a computer system operating on a local power supply of finite capacity has a plurality of system components each connected to a voltage supply system to draw current for their operation. The computer system includes a measuring circuit connected to detect prevailing usage of the local power supply, for example, a battery. The supply system is connected to receive an indication from the measuring circuit of excessive usage and is adapted to reduce the available supply voltage to selected ones of the system components. Each system component is associated with a clock controller which selects a clock frequency for operation of a component in dependence on the available voltage supply.

In embodiments, the clock controller may comprise a voltage controlled oscillator configured to receive the available supply to its associated components and to generate a clock signal with a frequency determined by the available supply voltage.

In embodiments, the local power supply of finite capacity may be a battery. The battery, the system components, the clock controllers and the measuring circuit may be housed within a common housing.

In embodiments, the system components may include one or more of the following: a processing component; a graphics component; and a communications component.

In embodiments, the computer system may comprise a configuration controller configured to generate a desired clock frequency for each component. Each component may be associated with a feedback controller configured to receive the desired clock frequency from the configuration controller and to compare the desired clock frequency with the frequency of the clock signal generated as determined by the available supply voltage. The feedback controller may be configured to generate a voltage request to adjust the available supply based on the comparison between the desired clock frequency and the clock signal with a frequency determined by the instant available supply voltage. The supply system may be configured to receive voltage requests from each of the system components and to manage the available supply delivered to each component based on these requests.

In embodiments, the supply system may be operative to reduce the available supply based on the indication from the measuring circuit of excessive usage, the supply system is configured to deliver an indication to the configuration controller that the available supply will be reduced. The configuration controller may be adapted to receive the indication of reduced available supply and is arranged to reconfigure the desired clock frequencies for each component. In embodiments, the configuration controller may comprise a processor arranged to execute configuration code.

In embodiments, the clock controller may be implemented in hardware.

In embodiments, the supply system may be adapted to reduce the available supply to selected ones of the system components in a predetermined sequence of components.

Also disclosed is a supply system for a computer device operating on a local power supply of finite capacity. The supply system comprises an input for receiving an indication from a measuring circuit which is configured to detect prevailing usage of a local power supply, the indication being of excessive usage of the power supply. The supply system also comprises a plurality of voltage supply outputs, each output being configured to be connected to a respective system component and to deliver an available supply voltage to that component. The supply system also comprises a supply controller configured to receive voltage requests from system components and to adjust the available voltage supply based on such voltage requests. The supply system is adapted to reduce the available supply to selected ones of the system components when it receives an indication from the measuring circuit of excessive usage, and to notify a configuration controller in that event.

In embodiments, the supply controller comprises a processing circuit configured to execute supply control software.

Also disclosed is method of supplying voltage to a computer device operating on a local power supply of finite capacity. The method comprises delivering a respective available supply voltage to system components, receiving voltage requests from the system components, and adjusting the available voltage supply based on the received voltage requests. The method further comprises receiving an indication from a measuring circuit of excessive usage of the local power supply, the measuring circuit being configured to detect prevailing usage of the local power supply. When said indication is received, the available supply to selected ones of the system components is reduced and a configuration controller is notified in that event.

For a better understanding of the present invention and to show how the same may be carried into effect, reference will now be made by way of example to the following drawings.

### BRIEF DESCRIPTION OF THE DRAWINGS

FIG. 1 is a schematic block diagram of a battery operated computer system.

### DESCRIPTION OF EMBODIMENTS

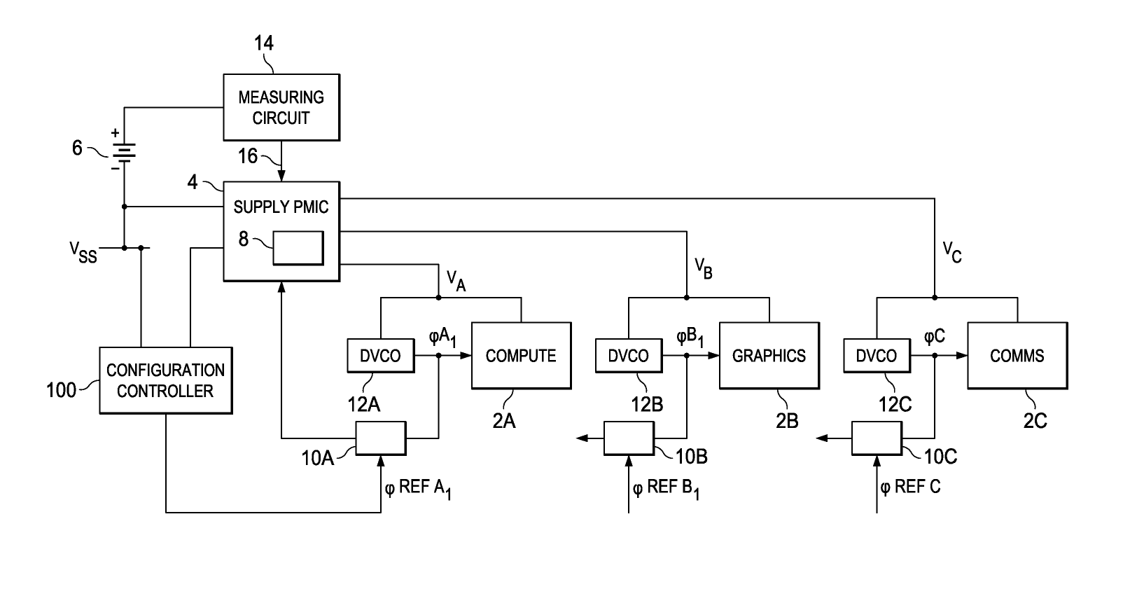

FIG. 1 is a schematic block diagram of a battery powered computer system. The computer system comprises a plurality of separately powered components 2A, 2B, 2C. Although three such components are illustrated it will be appreciated that any number of components could be present in the computer system. The component can be provided on a common integrated circuit or as separate integrated circuits within a common housing. According to the present disclosure, they are connected to a common supply system 4 which is connected to a battery 6. The supply system 4 is responsible for supplying an appropriate operating voltage to each of the components, the operating voltage marked VA, VB, VC. The supply system 4 incorporates a supply controller 8 which is able to supply different voltages to each of the components. In the computer system of FIG. 1, there is a compute component 2A, a graphics component 2B and a communications component 2C. The function of these components will be known to a person skilled in the art and so will not be described in detail herein. It will be evident for example that the graphics component is responsible for driving a display (not shown), and the communications component 2C is responsible for wireless communications (in the case of a handheld wireless device) with a network or other entity. Thus, the communications component 2C would be connected for example, to a network interface. The compute component 2A can be a processor or the like for executing processing routines for the management of the computer system. Each component is associated with a clock source 12A, 12B, 12C respectively. The clock sources 12 each supply a clock signal φA₁, φB₁, φC to its associated component for operating the component at the frequency of the clock.

The clock supplies 12A, 12B, 12C each receive the supply voltage VA, VB, VC respectively from the supply system 4 and control their associated clock φA₁, φB₁, φC based on that voltage, such that the frequency of the clock signal output from the clock 12 is dependent on the supply voltage. Thus, a lower voltage will result in a slower clock.

The clock supplies can be digital frequency locked loops (DFLL) of the type described for example, in WO 2011/104242. They are connected in a closed loop operation mode with the supply controller 8 as described in more detail later. The output clock signal φ is coupled to a feedback control means 10A, 10B,10C. The feedback control means 10A receives a control signal from a configuration controller 100 which has a frequency that is a function of the desired clock frequency for the component. Each component receives its own reference frequency φ_{REFA1}, φ_{REFB1}, φ_{REFC}, from the configuration controller 100. Note that the connecting lines are omitted in FIG. 1 to components 10B and 10C for the sake of clarity.

In operation the DVCO 12A generates an oscillating output signal. The frequency of the output signal generated by the DVCO 102 depends upon the supply voltage VA received at the DVCO 12A. The oscillating signal output from the DVCO 12A is output to the feedback controller 10A. In essence the output of the DVCO 12A is an oscillating signal φ with a frequency F_{A} that is varied by varying the supply voltage.

The feedback controller 10A operates to control the supply voltage. A voltage request VID_{A} is transmitted from the feedback controller 10A to the supply controller 8 to request a supply level consistent with delivering the frequency F_{A} consistent with φ_{REFA} determined by the configuration controller 100. The supply voltage VA is then fed back to the DVCO 12A to thereby control the frequency F_{A} of the output signal φ_{A}. In this way, the feedback controller creates a feedback loop such that the value of the output signal on line φ_{A} affects the generation of the supply voltage (VA) which thereby affects the generation of the output signal in the DVCO 12A. In uninterrupted, normal operation the digital frequency locked loop will reach a steady state for the average frequency F_{A} of the output signal and the supply voltage (VA).

A measuring circuit 14 is provided associated with the battery 6. The measuring circuit 14 measures the current or voltage of the battery. For example, it could take the form of a voltmeter connected in parallel to the battery, or an ammeter connected in series with the battery. The aim is to monitor the current drawn from the battery. When current drawn exceeds the battery capacity, the measuring circuit 14 detects it directly (if it is measuring current), or indirectly through a drop in the battery voltage (if it is measuring voltage). When an excessive prevailing usage of the battery is detected by the measuring circuit 14, an indication 16 is sent to the supply system 4. The supply system 4 responds by reducing the voltage to selected ones of the components 2A, 2B, 2C. The selected component will gracefully reduce their performance and hence current consumption due to the effect on the clock signal φ, the frequency of which depends on the voltage. As mentioned, this is achieved by use of closed loop DVS (DFLL clocking) where the instantaneous frequency is dependent on the supply voltage. This is an immediate hardware response, which allows the chip to continue at least some operations in the event of battery “droop”.

Components can be selected based on their function; for example, compute would be dropped or slowed before graphics, and graphics before comms to minimise the effect on a user.

The above described arrangement provides significant advantages in a battery operated computer system. Because the voltage supply to selected components is only reduced in real time when excessive usage of the battery is actually detected, it delivers a better user experience from a given battery and exploits the available silicon capabilities in real world designs.

In particular, it represents a significant improvement over a technique of estimating the current consumed by each component and controlling the voltage and frequency of parts of the circuit based on that estimate. This is error-prone and requires significant margining. Measuring the current consumed by each component can be impractical and budgeting in software cannot react fast enough to efficiently balance a change in current from each component and best use the available current.

The present technique also has advantages with respect to an arrangement where a system controller is implemented in a combination of software and hardware. A particular advantage of the technique described in the present disclosure is that the instantaneous frequency is derived in hardware from the supply voltage and therefore responds quickly. A software approach is limited to semi-static situations since it is slow.

Nevertheless, software can be used to augment the hardware approach discussed in the foregoing in a number of important respects. The configuration controller 100 has been mentioned as a source for reference frequencies for each of the components, 2A, 2B, 2C. The configuration controller 100 is itself preferably supplied by a fixed rail VSS which is maintained at a predetermined level so that the operation of the configuration controller can always be relied upon. In fact, the configuration controller would generally not draw a large current and so this is on the whole not too problematic.

The configuration controller 100 sets the desired frequencies for the components 2A, 2B, 2C based on overall operating intelligence within the device. In particular, it manages resources so as to optimise the operating speed of the components depending on the function which the components are to perform and the overall resources which are available. Once a required operating frequency is established for each component, that frequency controls, in normal operation, the voltage which is supplied by the supply manager 4 as described earlier. However, in the event of battery droop as monitored by the measuring circuit 14, normal operation can no longer be sustained. As already mentioned, an instantaneous hardware response is achieved through the DVCO clock supplies 12A, 12B, 12C which instantaneously reduce the clocks to their individual components. In addition to this immediate hardware response, the supply manager 4 informs the configuration controller 100 that a battery droop condition has occurred. This allows the configuration controller to adjust its resource levels to accommodate the reduced available battery voltage and so it, in its turn, reduces the demanded clock frequencies φ_{REF} to a more appropriate level in the newly constrained resources. In addition, the configuration controller could determine based on information from the measuring circuit supplied to the supply manager along line 16, the reason for over usage of the battery, and if necessary specifically adjust the operating speed of the particular component that caused the over usage when it can be ascertained from the details from the measuring circuit 14. In this way, the configuration controller 100 can reconfigure the chip and more intelligently distribute work across the chip so as to prevent a battery droop condition from occurring again, where this might be possible by work allocation.

Note that in this event, the voltage is requested by the messages VID will not be met by the supply controller 8. That is, the VID will request a certain voltage, but in fact a lower voltage will be delivered. This scenario is communicated to the configuration controller so that it understands that the components are not operating in accordance with their expected frequencies. As just explained, it will respond to this by reducing the required frequencies intelligently per component based on the overall requirements of the chip and the other resources available.

When the battery conditions improve again, the chip can be returned to its normal operating system.

This can be achieved in the following way. The feedback controller 10A operates in a closed feedback loop to supply a desired voltage to its component based on the reference frequency which is supplied from the configuration controller. Nevertheless, there is a cap on the available voltage that could be supplied to an individual component even in normal operation of the chip. In the event of battery droop, the configuration controller can instruct the supply controller 8 to reduce these caps as one way of reducing the supply voltages VA, VB, VC. Once a normal battery condition is detected again, the “artificial” cap can be removed and operation reverts to normal.

A particular merit is that the system described herein can react to the instantaneous state of the battery, the capacity of which can vary with temperature, age, etc.

While this invention has been particularly shown and described with reference to particular embodiments, it will be understood to those skilled in the art that various changes in form and detail may be made without departing from the scope of the invention as defined by the appended claims.

1. A computer system operating on a local power supply of finite capacity and having a plurality of system components each connected to a supply system to draw current for their operation, the computer system comprising:
a measuring circuit connected to detect prevailing usage of the local power supply, the supply system connected to receive an indication from the measuring circuit of excessive usage and adapted to reduce the available supply voltage to selected ones of the system components;
wherein each system component is associated with a clock controller operable to select a clock frequency for operation of the component in dependence on the available supply.

2. A computer system according to claim 1, wherein the clock controller comprises a voltage controlled oscillator configured to receive the available supply to its associated components and to generate a clock signal with a frequency determined by the available supply voltage.

3. A computer system according to claim 1, wherein the local power supply of finite capacity is a battery.

4. A computer system according to claim 3, wherein the battery, the system components, the clock controllers and the measuring circuit are housed within a common housing.

5. A computer system according to claim 1, wherein the system components include one or more of the following:
a processing component;
a graphics component; and
a communications component.

6. A computer system according to claim 1, comprising a configuration controller configured to generate a desired clock frequency for each component.

7. A computer system according to claim 6, wherein each component is associated with a feedback controller configured to receive the desired clock frequency from the configuration controller and to compare the desired clock frequency with the frequency of the clock signal generated as determined by the available supply voltage.

8. A computer system according to claim 7, wherein the feedback controller is configured to generate a voltage request to adjust the available supply based on the comparison between the desired clock frequency and the clock signal with a frequency determined by the instant available supply voltage.

9. A computer system according to claim 8, wherein the supply system is configured to receive voltage requests from each of the system components and to manage the available supply delivered to each component based on these requests.

10. A computer system according to claim 6, wherein when the supply system is operative to reduce the available supply based on the indication from the measuring circuit of excessive usage, the supply system is configured to deliver an indication to the configuration controller that the available supply will be reduced.

11. A computer system according to claim 10, wherein the configuration controller is adapted to receive the indication of reduced available supply and is arranged to reconfigure the desired clock frequencies for each component.

12. A computer system according to claim 6, wherein the configuration controller comprises a processor arranged to execute configuration code.

13. A computer system according to claim 1, wherein the clock controller is implemented in hardware.

14. A computer system according to claim 1, wherein the supply system is adapted to reduce the available supply to selected ones of the system components in a predetermined sequence of components.

15. A supply system for a computer device operating on a local power supply of finite capacity, the supply system comprising:
an input for receiving an indication from a measuring circuit which is configured to detect prevailing usage of a local power supply, the indication being of excessive usage of the power supply;
a plurality of voltage supply outputs, each output being configured to be connected to a respective system component and to deliver an available supply voltage to that component;
a supply controller configured to receive voltage requests from system components and to adjust the available voltage supply based on such voltage requests;
wherein the supply system is adapted to reduce the available supply to selected ones of the system components when it receives an indication from the measuring circuit of excessive usage, and to notify a configuration controller in that event.

16. A supply system according to claim 15, wherein the local power supply of finite capacity is a battery.

17. A supply system according to claim 15, wherein the system components include one or more of the following:
a processing component;
a graphics component; and
a communications component.

18. A supply system according to claim 15, wherein the supply system is adapted to reduce the available supply to selected ones of the system components in a predetermined sequence of components.

19. A supply system according to claim 15, wherein the supply controller comprises a processing circuit configured to execute supply control software.

20. A method of supplying voltage to a computer device operating on a local power supply of finite capacity, the method comprising:
delivering a respective available supply voltage to system components;
receiving voltage requests from the system components;
adjusting the available voltage supply based on the received voltage requests;
receiving an indication from a measuring circuit of excessive usage of the local power supply, the measuring circuit being configured to detect prevailing usage of the local power supply; and
when said indication is received, reducing the available supply to selected ones of the system components and notifying a configuration controller in that event.
